(19) United States
(12) Patent Application Publication
(10) Pub. No.: US 2002/0064212 A1
(43) Pub. Date: May 30, 2002

(54) Code-division-multiple-access receiver with zero correlation window

(76) Inventor: Daoben Li, Beijing (CN)

Correspondence Address: DAVID NEWMAN CHARTERED, Centennial Square, P.O. Box 2728, La Plata, MD, 20646-2728, US

(21) Appl. No.: 09/821,136

(22) Filed: Mar. 30, 2001

Related U.S. Application Data
(63) Continuation-in-part of application No. 09/763,289, filed on Feb. 21, 2001.
Application No. 09/763,289 is a 371 of international application No. PCT/CN00/00028, filed on Feb. 17, 2000.

(51) Int. Cl. H04K 1/00

(52) U.S. Cl. 375/150

(57) ABSTRACT

A spread-spectrum receiver using a spread-spectrum multiple-access codes in the area of wireless communications system that involves code-division-multiple access (CDMA) and spread-spectrum technology. The spread-spectrum receiver uses two orthogonal, synchronous fading channels to transmit two pairs of multiple access spreading codes respectively. The two pairs of spreading codes oppose each other but also complement each other in the transmission so that their correlation has a property of zero correlation window, i.e. the auto-correlation and cross-correlation functions have no side lobes within the zero correlation window. That means that inter symbol interference (ISI) and MAI will be completely eliminated in the corresponding CDMA and spread-spectrum system, so that makes it possible to build a wireless digital communications system of large RF capacity and solve the more severe contradictions between the resource of frequency efficiency and RF capacity.

### RELATED PATENT

This patent stems from a continuation-in-part (CIP) application of U.S. patent application Ser. No. 09/763,289, filed Feb. 21, 2001, entitled A SPREAD-SPECTRUM MULTIPLE ACCESS CODING METHOD WITH ZERO CORRELATION WINDOW, the specification for which an international patent application was filed Feb. 17, 2000, having International Application No. PCT/CN00/00028. The benefit of the earlier filing date of the parent U.S. patent application and PCT patent application are claimed for common subject matter pursuant to 35 U.S.C. §§ 119, 120 and 365.

### BACKGROUND OF THE INVENTION

This invention relates to a spread-spectrum and code-division-multiple-access (CDMA) wireless communication technology, and more particularly, to a spread-spectrum multiple access coding method having high spectral efficiency with a zero correlation window for use in a Personal Communication System (PCS).

### DESCRIPTION OF THE RELEVANT ART

The growing popularity of personal communication services coupled with the scarcity of radio bandwidth resources has resulted in the ever-increasing demand for higher spectral efficiency in wireless communications. Spectral efficiency refers to the maximum number of subscribers that can be supported in a cell or sector under a given bandwidth allocation and transmission rate requirement. The unit of spectral efficiency is the total transmission rate per unit bandwidth within a given cell or sector. Obviously, the better the spectral efficiency is, the higher the system capacity will be.

Traditional wireless Multiple Access Control (MAC) systems, such as Frequency Division Multiple Access (FDMA), Time Division Multiple Access (TDMA), result in system capacity that is limited by the time-bandwidth product. It is impossible to increase the number of supportable subscribers under these MAC schemes. For example, assume that the basic transmission rate of a subscriber is 1/T samples per second, where T is time, and the allocated bandwidth is B Hz. Then, the time-bandwidth product is BT, which is the maximum number of supportable subscribers. It is impossible to support more than BT subscribers in FDMA and TDMA systems.

The situation is completely different under a Code Division Multiple Access (CDMA) system where the system capacity only depends on the Signal-to-Interference Ratio (SIR). Increasing the number of subscriber reduces the SIR, thus lowering the transmission rate. However, a subscriber will not be denied radio resource allocation. In other words, unlike FDMA and TDMA systems, a CDMA system does not have a hard upper bound (i.e. BT) on the number of supportable subscribers.

The capacity of a CDMA system depends on the interference level. As such, the ability to accurately control the interference level is critical to the performance and the successful operation of a CDMA system. There are four sources of interference in a CDMA system: the first type of interference (or noise) comes from various sources in the local environment, which cannot be control by the wireless communication system. The only way to alleviate noise interference is to use a low noise amplifier. The second type of interference is Inter-Symbol-Interference (ISI). The third type of interference is Multiple Access Interference (MAI) that is originated from other subscribers in the same cell. The forth type of interference is Adjacent Channel or Cell Interference (ACI) that is originated from other subscribers in the neighboring channel or cell. It is possible to reduce or eliminate ISI, MAI, and ACI by using higher performance codes.

In a CDMA system, each subscriber has his/her own unique identification code. A code is a signal having a sequence of chips, and also is know as a chip-sequence signal. The uniqueness of identification of a code is based on the particular sequence of chips used for the code.

In addition, the subscribers' spread-spectrum codes are orthogonal to each other. The orthogonality requirement is common to all multiple access schemes. If the communications channel were an ideal linear time and frequency non-dispersion system, and the system had high degree of synchronization, then the subscribers stay orthogonal to each other. In reality, the communications channel is not ideal, and it is very difficult to achieve tight synchronization for communication channels with time and frequency dispersion. As a result, the ability to achieve orthogonality in a non-ideal communications channel with time and frequency dispersion is critical to the successful operation of CDMA systems.

It is commonly known that a mobile communications channel is a typical random time varying channel, with random frequency dispersion, due to Doppler shift effect, and random time dispersion, due to multi-path transmission effect. Random frequency dispersion results in the degradation in time selectivity of the received signal with unexpected fluctuation of the reception power level. Random time dispersion results in the degradation in frequency selectivity, which results in the unexpected variation in the reception level within each frequency component. This degradation results in reduced system performance and significantly lowers the system capacity. In particular, because of the time dispersion of the transmission channel, as a result of multi-path transmission, different signal paths do not arrive at the receiver at the same time. This results in the overlapping of neighboring symbols of the same subscriber and causes Inter Symbol Interference (ISI). On the other hand, the time dispersion of the channel worsens the multiple access interference. When the relative delay of signals of different subscribers are zero, any orthogonal code can achieve orthogonality. However, maintaining orthogonality is difficult if the relative delay of signals of subscribers were not zero.

In order to reduce ISI, the auto-correlation of each subscriber's access codes must be an ideal impulse function that has all energy at the origin, nowhere else. To reduce the MAI, the cross-correlations between multiple access codes of different subscribers must be zero for any relative delay. In the terms of orthogonality, each access code must be orthogonal to itself with non-zero time delay. The access codes must be orthogonal to each other for any relative delay, including zero delay.

For simplicity, the value of an auto-correlation function at the origin is called the main lobe and the values of auto-correlations and cross-correlations at other points are called side lobes. The correlation functions of ideal multiple access codes should have zero side lobes everywhere. Welch theory proved that there does not exist any ideal multiple access codes in the field of finite elements and even in field of complex numbers. The claim that ideal multiple access codes do not exist, is called the Welch bound. Especially, the side lobes of auto-correlation function and the side lobes of cross-correlation function are contradicted to each other; side lobes of one correlation function are small but the side lobes of the other correlation function become big. Furthermore, NASA had done brute force searching, by using a computer, to search for all ideal codes. However, there has not been a breakthrough. Since then, not much research work has been done on the search of the ideal multiple codes.

NASA searched for the good access codes in the Group codes and the Welch bound in the sub-fields of complex numbers. Beyond the field of complex numbers, the ideal codes could exist. For example, B. P. Schweitzer has found an approach to form ideal codes in his Ph.D thesis on “Generalized complementary code sets” in 1971. Later, Leppanen and Pentti (Nokia Telecommunication) extended Dr. Schweitser's results in the mixed TDMA and CDMA system. Their work has been granted a patent (No: 0600713A2; application number: 933095564). They broke the Welch bound in the high dimensional space. The utilization of frequency, however, is very low and thus there is no practical value. There has not been any application of their invention in nearly 30 years. According to their invention, in a system of N multiple access codes, their invention requires at least N² basic codes. Each basic code has length at least N chips. That means that N³ chips are needed to support N addresses. For example, when N=128, with 16QAM modulation, the coded spectral efficiency is only log₂ 16×128/128³=2.441×10⁻⁴ bits/Hz. The more access codes, the lower the utilization of the spectral efficiency. This coding methodology reminds us that ideal multiple access codes can be achieved via complementary code sets. We should, however, avoid that the code length grows too fast with the required number of multiple access codes.

In addition, with technique of two-way synchronization, the relative time delay within each access code or between each other in a random time varying channel will not be greater than the maximum time dispersion of the channel plus the maximum timing error. Assuming that value is Δ second, so long as their correlation functions do not have any side lobes in a time interval (−Δ,Δ), there are no MAI and ISI between the access codes. The time interval that possesses the above property is called “zero correlation window”. It is obvious that the corresponding CDMA system will be ideal when the “zero correlation window” size is wider than the maximum time dispersion deviation of the channel, i.e. the time delays among multi-paths of the signal, plus the maximum timing error. At the same time, it is also true that the near-far effects are no longer effective. The well-known near-far effects is created by the overlapping of the side lobe of a signal source that is close to the base station receiver and the main lobe of a signal source that is far away from the base station receiver. The side lobe over-kills the main lobe, which causes high interference. The accurate, complicated and fast power control mechanism has to been used to overcome the near-far effects so that the energy of signals must be basically the same at the base station receiver. However, within the “zero correlation window” of the multiple access codes, there are no side lobes in the auto-correlation functions and cross-correlation functions under the working condition. The near-far effects no longer exist in the system. The complicated and fast power control mechanism will become less important and optional.

### SUMMARY OF THE INVENTION

An object of the present invention is to provide a new coding method for use with a spread-spectrum transmitter to create a series of spread-spectrum multiple access codes that have the “Zero Correlation Window” in their auto-correlation functions and cross-correlation functions. The improvement to a spread-spectrum transmitter receives a spread-spectrum signal from a source, such as an antenna, cable, etc. The improvement includes receiver-code means, which is coupled to the spread-spectrum source. The receiver-code means spread-spectrum processes the spread-spectrum signal with a particular code-division-multiple-access (CDMA) code from a plurality of CDMA code, having a zero correlation window. The particular CDMA code has an auto-correlation function which has a value of zero except at an origin within a zero correlation window. A cross-correlation function of the particular CDMA code with other CDMA codes in the plurality of CDMA codes, within the zero correlation window, has a value of zero everywhere inside the zero correlation window.

Due to the creation of the “zero correlation window”, the fatal near-far effects in traditional CDMA radio communications is solved. The Multiple Access Interference (MAI) and the Inter-Symbol Interference (ISI) is eliminated. A high RF capacity radio system could be thus created based on the invention.

The spread-spectrum multiple access codes with “zero correlation window” according to the present invention has the following two properties: The auto-correlation functions are zero except at the origin where all energy resides. That means the multiple access codes are ideal in the sense that the access codes are orthogonal to themselves with any relative nonzero time delay. There exists a “zero correlation window” at the origin where the cross-correlation functions of spread-spectrum multiple access codes are zero everywhere inside the window. This means that the access codes are mutually orthogonal whenever the relative time delays are no more than the window size.

To achieve the above objective, the coding method of spread-spectrum multiple access codes with “Zero Correlation Window” according to the present invention includes the following steps:

Selecting a pair of basically orthogonal complementary code group (C1, S1), (C2, S2) with a code length N, in which the acylic auto-correlation and cross-correlation functions of code C and code S oppose each other but also complement each other except at the origin, after summarization of each other, the value of the auto-correlation and cross-correlation functions will be zero everywhere except at the origin.

Expanding the code length and code number of the pair of basically orthogonal complementary code group in a tree structure, according to the practically necessary maximum of subscriber access, the auto-correlation function of the expanded code group will be zero everywhere except at the origin, while the cross-correlation function will form a Zero Correlation Window around the origin with the size of the window≧2N−1.

The width of Zero Correlation Window should be more than or equal to the maximum of relative time delay within each access code or between each other in the system. The maximum of relative time delay will be determined by the maximum time dispersion of the channel plus the maximum timing error.

When applying the formed spread-spectrum access codes in practical project, it should be ensured that code C only operate with code C, including itself and other codes, and code S only with code S, including itself and other codes. Therefore, using two orthogonal propagation channels that are synchronous fading, the above code C and code S can be transmitted respectively, and the same information bits can be loaded on modulation, and then summarize their output after despreading and demodulating. For the two orthogonal propagation channels, code C and code S can be modulated respectively on polarized waves orthogonal with each other, or code C and code S can be put in two time slots that will not overlap with each other after transmission.

The step of expanding the code length and code number of the pair of basically orthogonal complementary code group in a tree structure, according to the present invention, refers to:

If (C1, S1), (C2, S2) were a pair of basically orthogonal complementary code group with code length N, then the two pairs of orthogonal complementary code group with each code length 2N can be generated in the following way:

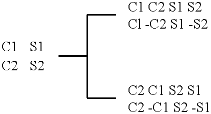

Wherein the values of auto-correlation functions of the orthogonal complementary code group formed on upper and lower trees after spread will be zero everywhere except at the origin, while the cross-correlation function will form a Zero Correlation Window around the origin with the size of the window≧2N−1.

The above spread can continue in accordance with the tree structure so as to generate 2ⁿ⁺¹ orthogonal complementary code groups with the code length N2ⁿ and the width of the zero correlation window≧2N−1, in which n=0, 1, 2, . . . is the number of spread times.

The equivalent transformation can be made to the generated orthogonal complementary code group.

The pair of basically orthogonal complementary code group (C1, S1), (C2, S2), according to the present invention, refers to that the auto-correlation function and cross-correlation function is respectively the summation of acylic auto-correlation with cross-correlation functions between codes C, and the summation of acylic auto-correlation with cross-correlation functions between codes S.

The code length and the width of the zero correlation window of the pair of basically orthogonal complementary code group can be spread in the following way:

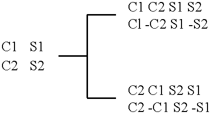

Wherein if each code length of the pair of basically orthogonal complementary code group (C1, S1), (C2, S2) is N, and the width of the zero correlation window is L, then each code length of the spread pair of basically orthogonal complementary code group will be 2N, while the width of the zero correlation window will be 2L+1.

When N=2, the pair of basically orthogonal complementary ode group will be:

(++, +−)

(−+, −−)

Wherein “+” means +1 and “−” means −1, while the width of the zero correlation window will be 3.

The above spread can continue in accordance with the tree structure so as to generate 2ⁿ pairs of orthogonal complementary code groups with the code length N2ⁿ and the width of the zero correlation window as 2ⁿL+2ⁿ⁻¹+2ⁿ⁻²+2ⁿ⁻³+ . . . +2¹+1, in which n=0, 1, 2, . . . is the number of spread times.

The equivalent transformation can be made to the generated basically orthogonal complementary code group.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1 is a first schematic diagram of a generation tree of an orthogonal complementary code group with zero correlation window in the present invention;

FIG. 2 is a second schematic diagram of the generation tree of the orthogonal complementary code group with zero correlation window in the present invention;

FIG. 3 is a schematic diagram of the generation tree of the basically orthogonal complementary code group in the present invention;

FIG. 4 is a block diagram of a spread-spectrum transmitter with a code generator;

FIG. 5, is a block diagram of a spread-spectrum transmitter with a memory;

FIG. 6 is a block diagram of a spread-spectrum receiver with a product detector; and

FIG. 7 is a block diagram of a spread-spectrum receiver with a matched filter.

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several views.

The coding steps of the present invention are described hereinafter beginning with the basic code group with its code length 2 and the access number 2.

Given two sets of codes of length 2, C Set: C1=(+, +), C2=(−, +) and S Set: S1=(+, −), S2=(−, −); wherein “+” means +1 and “−” means −1.

It is true that without any shift between each other (relative time delay), each pair of {C1, C2}, {S1, S2}, {C1, S1}, {C2, S2} are mutually orthogonal, i.e. their cross-correlation functions have zero value at the origin. However, with shift between each other (relative time delay), the mutual orthogonal property may not exist, i.e. the cross-correlation functions have non-zero values except at the origin. Table 1 shows the auto-correlation and cross-correlation functions values of codes C1 and C2 with different shifts. Table 2 shows the auto-correlation and cross-correlation values of codes S1 and S2 with different shifts.

TABLE 1
Correlation of the C Codes: C1 = (+ +); C2 = (− +)

| Time shift τ | | | |
|---|---|---|---|
| Correlation | −1 | 0 | 1 |
| R_{c}_{₁} (τ) | 1 | 2 | 1 |
| R_{c}_{₂} (τ) | −1 | 2 | −1 |
| R_{c}_{₁}_{c}_{₂} (τ) | 1 | 0 | −1 |

TABLE 2
Correlation of the S codes: S1 = (+ −); S2 = (− −)

| Time shift τ | | | |
|---|---|---|---|
| Correlation | −1 | 0 | 1 |
| Rₛ_{₁} (τ) | −1 | 2 | −1 |
| Rₛ_{₂} (τ) | 1 | 2 | 1 |
| Rₛ_{₁}ₛ_{₂} (τ) | −1 | 0 | 1 |

Tablers 1 and 2 show that both codes are not ideal. However, when adding these two tables together, the codes become ideal (See Table 3).

Now Define auto-correlation functions

R₁(τ)⁶⁶ =R_{c}_{₁}(τ)+R_{c}_{₂}(τ), R₂(τ)^{Δ}=R_{c}_{₂}(τ)+Rₛ_{₂}(τ),

and cross-correlation functions

R₁_{₂}(τ)^{Δ}=R_{c}_{₁}_{c}_{₂}(τ)+Rₛ_{₁}ₛ_{₂}(τ).

With the above new definition of correlation functions, i.e. the new correlation functions, including the auto-correlation function and cross-correlation function, are a summation of the correlation functions of C codes and the correlation functions of S codes, the values of auto-correaltion function and cross-correlation function of the codes one and codes two become ideal.

Such codes C and S can be called “complementary orthogonal” if C and S are ideal under the new definition of correlation functions R₁(τ), R₂(τ), and R₁_{₂}(τ) i.e. their correlation functions are opposed and complemented to each other except the origin. The above C and S code sets can be, for convenience, expressed as (C1, S1)=(+ +, + −) and (C2, S2)=(− +, − −).

Table 3 shows the correlation functions of the complementary orthogonal codes.

TABLE 3
Correlation of C and S codes (C1, S1) = (+ +; + −);
(C2, C2) = (− +; − −)

| Time shift τ | | | |
|---|---|---|---|
| Correlation | −1 | 0 | 1 |
| R₁ (τ) [symbol] R_{c}_{₁} (τ) + Rₛ_{₁} (τ) | 0 | 4 | 0 |
| R₂ (τ) [symbol] R_{c}_{₂} (τ) + Rₛ_{₂} (τ) | 0 | 4 | 0 |
| R₁₂ (τ) [symbol] R_{c}_{₁}_{c}_{₂} (τ) + Rₛ_{₁}ₛ_{₂} (τ) | 0 | 0 | 0 |

There is only one basic form for the orthogonal complementary code group with the number of access code 2 and each code length 2. It is proven that the C set of codes C1=(+ +), C2=(− +) and the S set of codes: S1=(+ −), S2=(− −) are the basic form of complementary orthogonal codes of length 2. Other forms can be obtained from re-ordering of C1 and C2, S1 and S2, swapping C and S, rotation, order reverse, interleaving polarity, and alternative negation etc without any substantial differences. The operation of code C with code C and code S with code S only should take place when correlating or matching filtering. Code C and code S will not encounter an operation.

For a longer code, for example, the orthogonal complementary code group with the number of access code 2 and each code length 4 can be obtained from the above basically orthogonal complementary code group. One of the generation methods is:

Let

(C1′, S1′)=(C1 C2, S1 S2);

(C2′, S2′)=(C1−C2, S1−S2);

Wherein C1′ means the concatenation of original code C1 and C2;

C2′ means the concatenation of C1 and the negation of the C2. Same operations could be applied to S1′ and S2′. They can be expressed as:

(C1, S1′)=(+ + − +, + − − −);

(C2, S2′)=(+ + + −, + − + +);

Table 4 shows the orthogonal complementary correlation functions of the new code group. It can be seen that the complementary auto-correlation function and cross-correlation function are all ideal.

The other way is reversing the order of the codes, that is:

(C1″, S1″)=(C2C1, S2S1)=(− + + +, − − + −)

(C2″, S2″)=(C2−C1, S2−S1)=(− + − −, − − − +)

The complementary auto-correlation function and cross-correlation function are also ideal. The orthogonal complementary correlation functions of the new code group are the same with those of the above code group. (See Table 4) Table 4: The Orthogonal Complementary Correlation Functions (each code length is 2²=4):

(C1′, S1′)=(+ + − +, + − − −);

(C2′, S2′)=(+ + + −, + − + +);

or

(C1″, S1″)=(− + + +, − − + −)

(C2″, S2″)=(− + − −, − − − +)

| Time shift τ | | | | | | | |
|---|---|---|---|---|---|---|---|
| Correlation | −3 | −2 | −1 | 0 | 1 | 2 | 3 |
| R₁(τ) = R_{c}_{₁}(τ) + Rₛ_{₁}(τ) | 0 | 0 | 0 | 8 | 0 | 0 | 0 |
| R₂(τ) = R_{c}_{₂}(τ) + Rₛ_{₂}(τ) | 0 | 0 | 0 | 8 | 0 | 0 | 0 |
| R₁₂(τ) = R_{c}_{₁}_{c}_{₂}(τ) + Rₛ_{₁}ₛ_{₂}(τ) | 0 | 0 | 0 | 0 | 0 | 0 | 0 |

With this way going on, the orthogonal complementary code group with the number of access code 2 and each code length 2ⁿ (n=1, 2 . . . ) can be obtained. It can be proved that their auto-correlation and cross-correlation functions are all ideal. Although the auto-correlation and cross-correlation functions of the access codes formed by this coding method, however, are ideal, the number of the access codes is only 2. It is apparent that two access codes are too small for a CDMA communications system. In practice, it is required that the number of the orthogonal access codes be as many as possible under the condition of given code length, while their auto-correlation and cross-correlation functions are not necessarily ideal everywhere. It is desirable that there is a zero correlation window around the origin that can meet the needs.

In fact, renumbering and arranging the above four complementary code groups with each code length 4, the result can be as follows:

(C1, S1)=(+ + − +, + − − −); (C2, S2)=(+ + + −, + − + +)

(C3, S3)=(− + + +, − − + −); (C4, S4)=(− + − −, − − − +)

Table 5 shows the correlation functions of the complementary code group.

Table 5: The Correlation Matrix of Codes (each code length is 2²=4):

(C1, S1)=(+ + − +, + − − −); (C2, S2)=(+ + + −, + − + +)

(C3, S3)=(− + + +, − − + −); (C4, S4)=(− + − −, − − − +)

| $\frac{Time shift τ}{Correlation}$ | −3 | −2 | −1 | 0 | 1 | 2 | 3 |
|---|---|---|---|---|---|---|---|
| ${R}_{1} ( τ ) {=}^{Δ} {R}_{{c}_{1}} ( τ ) + {R}_{{s}_{1}} ( τ )$ | 0 | 0 | 0 | 8 | 0 | 0 | 0 |
| ${R}_{2} ( τ ) {=}^{Δ} {R}_{{c}_{2}} ( τ ) + {R}_{{s}_{2}} ( τ )$ | 0 | 0 | 0 | 8 | 0 | 0 | 0 |
| ${R}_{3} ( τ ) {=}^{Δ} {R}_{{c}_{3}} ( τ ) + {R}_{{s}_{3}} ( τ )$ | 0 | 0 | 0 | 8 | 0 | 0 | 0 |
| ${R}_{4} ( τ ) {=}^{Δ} {R}_{{c}_{4}} ( τ ) + {R}_{{s}_{4}} ( τ )$ | 0 | 0 | 0 | 8 | 0 | 0 | 0 |
| ${R}_{12} ( τ ) {=}^{Δ} {R}_{{c}_{1} {c}_{2}} ( τ ) + {R}_{{s}_{1} {s}_{2}} ( τ )$ | 0 | 0 | 0 | 0 | 0 | 0 | 0 |
| ${R}_{34} ( τ ) {=}^{Δ} {R}_{{c}_{3} {c}_{4}} ( τ ) + {R}_{{s}_{3} {s}_{4}} ( τ )$ | 0 | 0 | 0 | 0 | 0 | 0 | 0 |
| ${R}_{13} ( τ ) {=}^{Δ} {R}_{{c}_{1} {c}_{3}} ( τ ) + {R}_{{s}_{1} {s}_{3}} ( τ )$ | 0 | 4 | 0 | 0 | 0 | 4 | 0 |
| ${R}_{14} ( τ ) {=}^{Δ} {R}_{{c}_{1} {c}_{4}} ( τ ) + {R}_{{s}_{1} {s}_{4}} ( τ )$ | 0 | −4 | 0 | 0 | 0 | 4 | 0 |
| ${R}_{23} ( τ ) {=}^{Δ} {R}_{{c}_{2} {c}_{3}} ( τ ) + {R}_{{s}_{2} {s}_{3}} ( τ )$ | 0 | 4 | 0 | 0 | 0 | −4 | 0 |
| ${R}_{24} ( τ ) {=}^{Δ} {R}_{{c}_{2} {c}_{4}} ( τ ) + {R}_{{s}_{2} {s}_{4}} ( τ )$ | 0 | −4 | 0 | 0 | 0 | −4 | 0 |

Wherein (C1, S1) and (C2, S2), (C3, S3) and(C4, S4) are the pair of orthogonal complementary code group with ideal property respectively, but the cross-correlation functions between groups are not ideal. For example, R₁₃(T) and R14(i) , R₂₃(T) and R₂₄(T) are not zero everywhere, but there is a zero correlation window with the size of 3 chips wide. Thus, an orthogonal complementary code group with the number of access codes 4, each code length 4, and a zero correlation window can be obtained.

The reason that the size of the zero correlation window is 3 is because the above four orthogonal complementary code groups include the basically orthogonal complementary code group with each code length 2, i.e. (C1, S1) (+ +, + −) and (C2, S2) (− +, − −), while the basic code group has only three status of time shift, i.e. −1, 0, and 1, because of each code length 2. In the ideal cases, only zero correlation window with the size of 3 can be obtained.

To generate a wide window of zero correlation, the C1 and S1 codes are required to increase their sizes. For example, the code length can be 4. There are two pairs of completely orthogonal basic complementary code group with each code length 4.

They are: (+ + − +, + − − −), (+ + + −, + − + +), and (− + ++, − − + −), (− +−−, − − +). Supposing that the first pair of code group is the original orthogonal complementary code group, four pairs of orthogonal complementary code group with each code length 8 can be generated following the aforementioned methods.

They are: (C1, S1)=(+ + − + + + + −, + − − − + − + +); (C2, S2)=(+ + − + − − − +, + − − − − + − −); and (C3, S3)=(+ + + − + + − +, + − + + + − − −); (C4, S4)=(+ + + − + − + − + + − + + +)

The size of their zero correlation window is 7 chips wide.

The correlation functions of these orthogonal complementary codes group are presented in the following matrix of Table 6:

Table 6 Correlation Matrix of codes (each code length 2³=8):

(C1, S1)=(+ + − + + + + −, + − − − + − + +);

(C2, S2)=(+ + − + − − − +, + − − − − + − −);

(C3, S3)=(+ + + − + + − +, + − + + + − − −);

(C4, S4)=(+ + + − − − + −, + − + + − + + +)

| $\frac{Tine shift τ}{Correlation}$ | −7 | −6 | −5 | −4 | −3 | −2 | −1 | 0 | 1 | 2 | 3 | 4 | 5 | 6 | 7 |
|---|---|---|---|---|---|---|---|---|---|---|---|---|---|---|---|
| ${R}_{1} ( τ ) {=}^{Δ} {R}_{{c}_{1}} ( τ ) + {R}_{{s}_{1}} ( τ )$ | 0 | 0 | 0 | 0 | 0 | 0 | 0 | 16 | 0 | 0 | 0 | 0 | 0 | 0 | 0 |
| ${R}_{2} ( τ ) {=}^{Δ} {R}_{{c}_{2}} ( τ ) + {R}_{{s}_{2}} ( τ )$ | 0 | 0 | 0 | 0 | 0 | 0 | 0 | 16 | 0 | 0 | 0 | 0 | 0 | 0 | 0 |
| ${R}_{3} ( τ ) {=}^{Δ} {R}_{{c}_{3}} ( τ ) + {R}_{{s}_{3}} ( τ )$ | 0 | 0 | 0 | 0 | 0 | 0 | 0 | 16 | 0 | 0 | 0 | 0 | 0 | 0 | 0 |
| ${R}_{4} ( τ ) {=}^{Δ} {R}_{{c}_{4}} ( τ ) + {R}_{{s}_{4}} ( τ )$ | 0 | 0 | 0 | 0 | 0 | 0 | 0 | 16 | 0 | 0 | 0 | 0 | 0 | 0 | 0 |
| ${R}_{12} ( τ ) {=}^{Δ} {R}_{{c}_{1} {c}_{2}} ( τ ) + {R}_{{s}_{1} {s}_{2}} ( τ )$ | 0 | 0 | 0 | 0 | 0 | 0 | 0 | 0 | 0 | 0 | 0 | 0 | 0 | 0 | 0 |
| ${R}_{34} ( τ ) {=}^{Δ} {R}_{{c}_{3} {c}_{4}} ( τ ) + {R}_{{s}_{3} {s}_{4}} ( τ )$ | 0 | 0 | 0 | 0 | 0 | 0 | 0 | 0 | 0 | 0 | 0 | 0 | 0 | 0 | 0 |
| ${R}_{13} ( τ ) {=}^{Δ} {R}_{{c}_{1} {c}_{3}} ( τ ) + {R}_{{s}_{1} {s}_{3}} ( τ )$ | 0 | 0 | 0 | 8 | 0 | 0 | 0 | 0 | 0 | 0 | 0 | 8 | 0 | 0 | 0 |
| ${R}_{14} ( τ ) {=}^{Δ} {R}_{{c}_{1} {c}_{4}} ( τ ) + {R}_{{s}_{1} {s}_{4}} ( τ )$ | 0 | 0 | 0 | −8 | 0 | 0 | 0 | 0 | 0 | 0 | 0 | 8 | 0 | 0 | 0 |
| ${R}_{23} ( τ ) {=}^{Δ} {R}_{{c}_{2} {c}_{3}} ( τ ) + {R}_{{s}_{2} {s}_{3}} ( τ )$ | 0 | 0 | 0 | 8 | 0 | 0 | 0 | 0 | 0 | 0 | 0 | −8 | 0 | 0 | 0 |
| ${R}_{24} ( τ ) {=}^{Δ} {R}_{{c}_{2} {c}_{4}} ( τ ) + {R}_{{s}_{2} {s}_{4}} ( τ )$ | 0 | 0 | 0 | −8 | 0 | 0 | 0 | 0 | 0 | 0 | 0 | −8 | 0 | 0 | 0 |

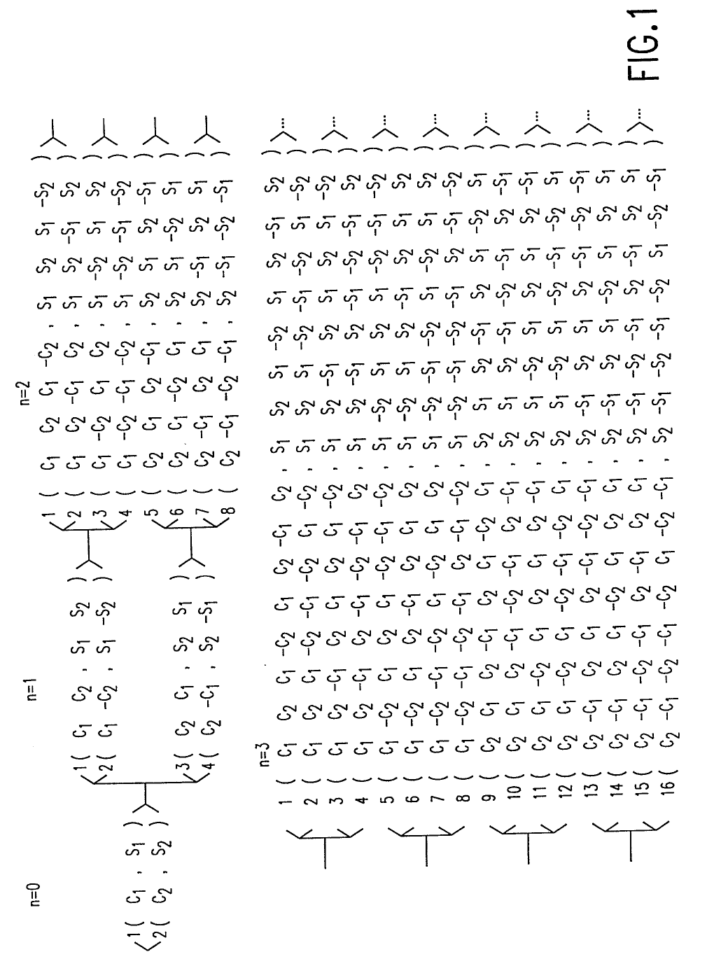

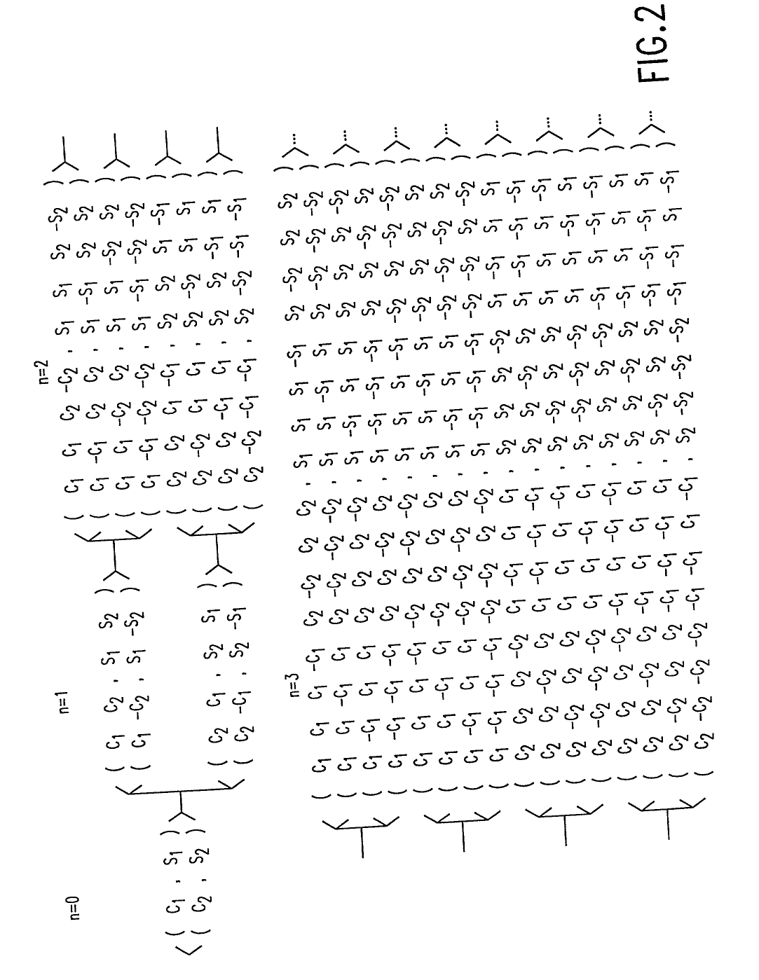

Two pairs of four new orthogonal complementary codes groups can be obtained from one pair of orthogonal complementary codes groups, with each code length doubled. Four pairs of eight orthogonal complementary codes groups can be further derived from these two pairs of four orthogonal complementary codes groups, and then, analogically in this way, eight pairs of sixteen orthogonal complementary codes groups can be derived, wherein the auto-correlation functions of each codes group and the cross-correlation functions between inside codes groups are all ideal, while the cross-correlation functions of the codes groups between pairs have a zero correlation window with its size depending on the original orthogonal complementary code group. The process can be illustrated by some drawing of generation tree. FIG. 1 shows one of such generation tree, FIG. 2 is another one. There are many others of generation trees; the relations between them are an equivalent transformation. Such transformation does not change the size of zero correlation windows. However, it sometimes changes the value of side lobes and their distribution outside the “zero correlation window”.

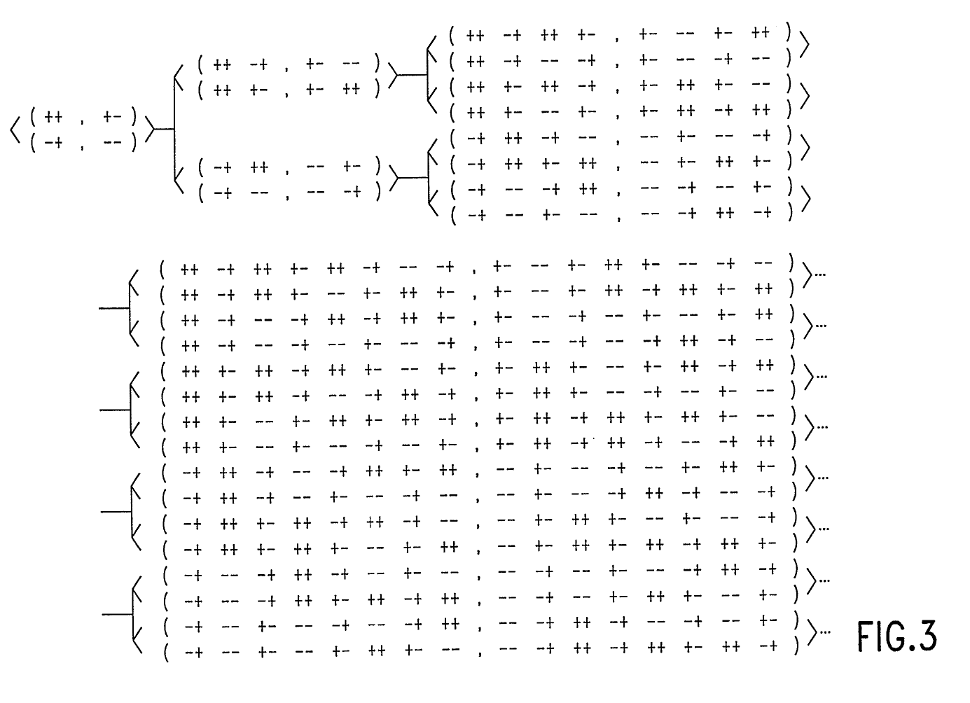

FIG. 3 shows a basic pair of complementary code group which will be used in the actual coding process of multiple access codes. In FIG. 3, all pairs of code group in “< >” are basic pair of orthogonal complementary code group without any side lobes for their complementary auto-correlation functions and cross-correlation functions, that is to say, totally ideal. It should be noted that FIG. 3 shows only a pair of basically orthogonal complementary code group; there are many ways of equivalent transformations, such as swapping the order of up and down or left and right, reversing the order of forwards and backwards, making alternately negation, rotating in complex plane, etc, in which equivalent pair of basically orthogonal complementary code group can be obtained with completely ideal auto-correlation and cross-correlation functions.

The construction process of the spread-spectrum access codes according to the present invention will be described in detail below.

Firstly, determine the required size of zero correlation windows according to the propagation conditions of the applied system, the basic spread-spectrum code bit rate, referred to as Chip Rate in terms of engineering, calculated as MCPS, used by the system, and the maximum timing error in the system.

Secondly, according to the required size of zero correlation window, select any pair of basically orthogonal complementary code group with its size of zero correlation window greater than or equal to the required window size as the original orthogonal complementary code group, and refer to it as (C1, S1) , (C2, S2).

Then, determine the required maximum number of subscriber accesses according to the actual number of subscribers, and spread the selected original pair of basically orthogonal complementary code group as the origin of FIG. 2 or FIG. 3 in the tree view.

The number of spreading stages in FIG. 2 or FIG. 3 is dependent on the required maximum number of subscribers. For example, when the number of the required maximum number of subscribers is 120, because of 2⁷=128≧120, then the required number of spreading stages is 7, while the 2⁷=128 group of codes in the 7^{th} stage of FIG. 2 or FIG. 3 can be the selected multiple access codes. At this time, the actual maximum number of subscriber accesses is 128, it is larger than 120, the required number of subscribers, and meets the needs completely.

In the practice of engineering, sometimes more mutations or variations of the access codes are needed. It needs to make equivalent transformation for the generated multiple access codes. The types of such transformations are so many that enumeration one by one is not necessarily. Here give the most common of equivalent transformations as follows:

Swapping the position of code C and code S.

Swapping the positions of C1 and C2 and S1 and S2 simultaneously.

Making negation to the order of codes.

Making negation to each code bit.

Interlacing the polarity of each code bit: for example, for (+ + − +, + − − −), (+ + + −, + − + +), interlace the polarity of each code bit, that is to say, the polarity of the odd code bits, such as the first, the third bit, etc, will remain unchanged, while the polarity of the even code bits, such as the second, the fourth bit etc, will change. So (+ − − −, + + − +), (+ − + +, + + + −) will result from this transformation. In like manner, the polarity of the odd code bits can be changed, while the polarity of the even code bits unchanged.

Rotating each code bit in complex plane: for example, by rotating in turn each code bit of (+ + − +, + − − −), (+ + + −, + − + +) at α angular degree, the following result will be obtained:

(ρ^{jφ}^{_{c1}}ρ^{j(φ}^{_{c1}}^{+α)}−ρ^{j(φ}^{_{c1}}^{+2α)}ρ^{j(φ}^{_{c1}}^{+3α)}, ρ^{jφ}^{ₛ₁}−ρ^{j(φ}^{ₛ₁}^{+α)}−ρ^{j(φ}^{ₛ₁}^{+2α)}−ρ^{j(φ}^{ₛ₁}^{+3α)}

(ρ^{jφ}^{_{c2}}ρ^{j(φ}^{_{c2}}^{+α)}ρ^{j(φ}^{_{c2}}^{+2α)}−ρ^{j(φ}^{_{c2}}^{+3α)}, ρ^{jφ}^{ₛ₂}−ρ^{j(φ}^{ₛ₂}^{+α)}ρ^{j(φ}^{ₛ₂}^{+2α)}ρ^{j(φ}^{ₛ₂}^{+3α)}

Here φ_{C1}, φ_{C2}, φ_{S1}, and φ_{S2} can be any initial angular degree. It can be proven that the properties of auto-correlation and cross-correlation functions of each resultant access code are still unchanged after rotating transformation. However, the side lobes outside “zero correlation window” are relating to the rotating angular degree (being narrower or changing polarity). The aforementioned basically orthogonal complementary code group can be deemed as the code group with zero rotating angular degree.

Selecting properly the different rotating angular degree can make the rotated code groups orthogonal between them, i.e. multi groups of orthogonal codes can be generated from one group of orthogonal codes. This will be very convenient for the engineering application, especially when the code length is a little bit longer, sometimes the result will be so wonderful that it could meet various of actual needs of engineering, such as networking configuration, handoff/handovers, as well as the enhancement of RF capacity, etc.

Making transformation in the generation tree: for example, FIG. 3 is a kind of equivalent transform of FIG. 2, i.e. by moving all C1 codes and S1 codes to the left, C2 codes and S2 codes to the right in the corresponding C code and S code position; and interlacing, in certain rules, the code bits of C code and S code in the resulted multiple access codes groups, or changing the polarity arrangement, etc. In Mathematics, such transformation is called equivalent transformation. There are a lot of equivalent transforms that are impossible to enumerate one by one.

When applying the formed spread-spectrum access codes in practice, it should be ensured that code C only operate with code C (including itself and other codes), and code S only with code S (including itself and other codes). Code C is never allowed to encounter code S. Therefore, the special parting measures should be taken in the actual application. For example, code C and code S can be modulated respectively on polarized waves (horizontal and vertical polarized waves, laevorotation and dextrorotation polarized waves) orthogonal with each other. Another example, code C and code S can be put in two time slots that will not overlap with each other after transmission. Because the propagation channels will change randomly with time, the channel properties within the two polarized waves and two time slots should be kept synchronous in the propagation process to ensure the complementarity. In terms of engineering, their fading should be synchronous. This means that when parting by polarization, the frequency channel without depolarization that can ensure the orthogonal polarized waves fading synchronously and corresponding measures should be used; when parting by time division, it should be ensured that the gap between two time slots is far less than the correlation time of channel; when using other parting methods, the synchronous fading should also be ensured.

Because code C and code S should be parted when propagation, and in the meantime, to utilize their complementarity, it is clear that the data bits modulated on them should be identical, while the outputs after de-spreading and demodulation of code C and code S should be added together.

The coding method of the present invention presents a linear relation, because the total required number of code bits is only in direct proportion to the required number of accesses (about twofold). It moves forwards more creative step compared with the results of Dr. B. P. Schweitzer , Leppanen and Pentti. In their methods, the total required number of code bits is a cube relation with the required number of accesses. Therefore, it can be said that using the CDMA system according to the present invention will have much higher spectrum efficiency.

The present invention has been fully verified by computer simulation for four years. Under the same conditions, such as propagation fading, widening of multipath transmission, system bandwidth, subscriber transmission rate, and frame structure, as those of the first commercial CDMA standard in the world, i.e. IS-95, the spectrum efficiency of the system, when using the multiple access code system of the present invention, will be at least sixfold as that of IS-95.

CDMA Transmitter With Zero Correlation Window CDMA Codes

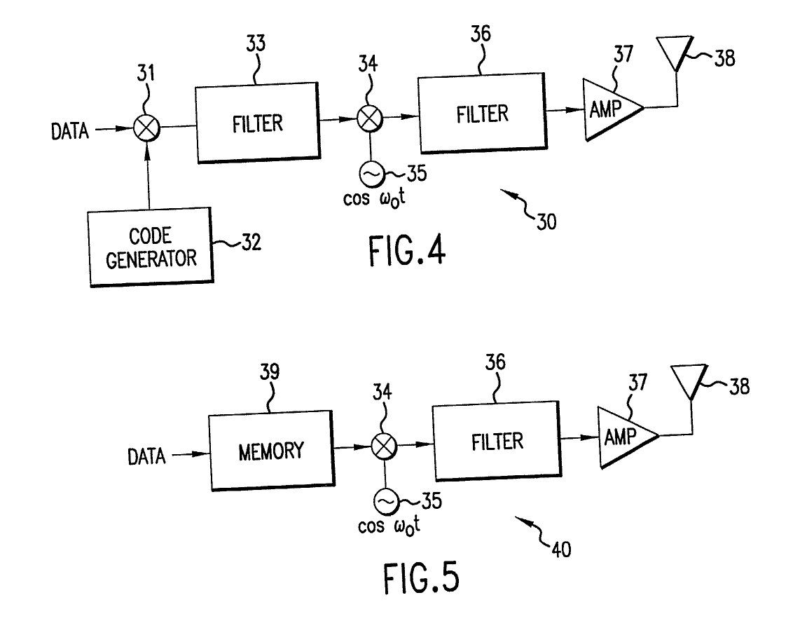

The CDMA codes having a zero correlation window may be used in a spread-spectrum transmitter. In the exemplary arrangement shown in FIGS. 4 and 5, representative spread-spectrum transmitters 30, 40 are shown. Data from a data source are processed by transmitter-code means, to generate a spread signal. The transmitter-code means spread-spectrum processes the data with a particular code-division-multiple-access (CDMA) code from a plurality of CDMA codes. The plurality of CDMA codes have the zero correlation window with a respective auto-correlation function. The zero correlation window has a value of zero except at an origin. A particular CDMA code of the plurality of CDMA codes has a cross-correlation function with other CDMA codes in the plurality of CDMA codes, within the zero correlation window. The cross-correlation function has a value of zero everywhere inside the zero correlation window.

The spread-spectrum-processed signal is raised to a carrier frequency by product device 34, to generate a spread-spectrum signal with carrier signal cos (ω₀t) at a carrier frequency f₀. The carrier signal cos (ω₀t) at the carrier frequency f₀ is from signal source 35. The output from the product device 34 is filtered by filter 36. Filter 36 typically is a bandpass filter, with a bandwidth centered at the carrier frequency f₀ and a bandwidth sufficiently wide to pass the spread-spectrum signal. The spread-spectrum signal is amplified by amplifier 37 and radiated by antenna 38.

In FIG. 4, the transmitter-code means to generate the spread-spectrum-processed signal, includes a code generator 32, product device 31 and filter 33. The product device 32 is connected or coupled to the code generator 32 and between the data source and filter 33. The code generator 32 generates the particular CDMA code from the plurality of CDMA code, and any of the other CDMA code in the plurality of CDMA codes. The product device 31 spread-spectrum processes the data with the particular CDMA code. The filter 33 filters the spread-spectrum processed signal.

In FIG. 5, the transmitter-code means to generate the spread-spectrum processed signal, includes a memory 39. The memory 39 may be a disk, RAM, or other memory. Memory devices and medium are well known in the art. The data includes symbols. In a simple form, the symbols are 1-bits and 0-bits. Multiple bit symbols, however, may is included. In response to a particular symbol of a plurality of symbols from the data source, the memory 39 outputs the particular CDMA code from the plurality of CDMA codes stored in the memory 39. The mapping of symbols to CDMA codes preferably is one-to-one.

The spread-spectrum transmitters 30, 40 of are only representative, and as is well-known in the art, my be embodied with more or additional features and technology. The present invention can be used with more advanced spread-spectrum transmitters than those depicted in FIGS. 4 and 5.

Spread-Spectrum Receiver With Zero Correlation Window CDMA Codes

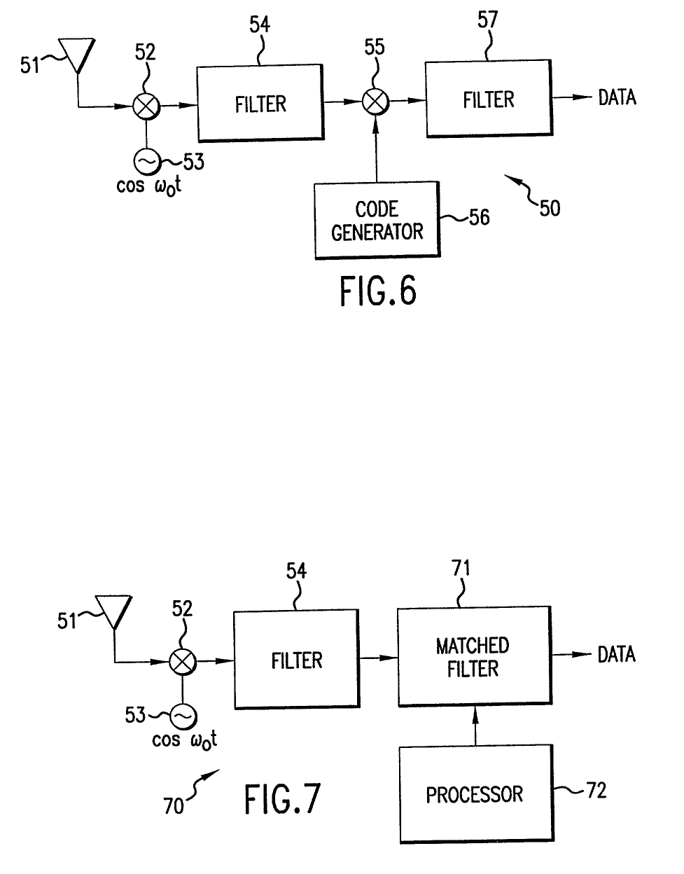

The exemplary drawings of FIGS. 6 and 7 show two embodiments of spread-spectrum receivers 50, 70 which may be used to receive a spread-spectrum signal having the particular CDMA code with the zero correlation window. The received spread-spectrum signal was transmitted by a spread-spectrum transmitter using the particular CDMA code with the zero correlation window. The typical spread-spectrum source is an antenna 51, but other sources my be used, such as a cable, or other communications channel. Typically a signal source 53 generates the carrier signal cos (ω₀t) at a carrier frequency f₀. A mixer 52 mixes the spread-spectrum signal with the carrier signal cos (ω₀t) at a carrier frequency f₀, for baseband processing. Other frequencies, such as an intermediate frequency, may be used for processing the spread-spectrum signal. The filter 54 filters to spread-spectrum signal at the processing frequency. Such technology is well-known in the art.

The receiver-code means spread-spectrum processes the spread-spectrum signal with a replica of the particular CDMA code from the plurality of CDMA codes. The replica of the particular CDMA code has a zero correlation window, and an auto-correlation function, within the zero correlation window, having a value of zero except at an origin. The replica of the particular CDMA code has a cross-correlation function with other CDMA codes in the plurality of CDMA codes, within the zero correlation window, having a value of zero everywhere inside the zero correlation window.

In FIG. 6, the receiver-code means is embodied as a receiver-code generator 56 a mixer 55 and as filter 57. The mixer 55 is coupled between the filter 54 and the filter 57, and to the code generator 56. The receiver-code generator 56 generates the replica of the particular CDMA code from the plurality of CDMA code. The mixer 55 spread-spectrum processes the spread-spectrum signal at the processing frequency with the replica of the particular CDMA code. The filter 57 filters the processed spread-spectrum signal, to output data.

The receiver-code generator 56 generates the replica of the particular CDMA code with the zero correlation window, and an auto-correlation function, within the zero correlation window, having a value of zero except at an origin. The replica of the particular CDMA code has a cross-correlation function with other CDMA codes in the plurality of CDMA codes, within the zero correlation window, having a value of zero everywhere inside the zero correlation window. The receiver-code generator 56 my include a memory for storing the replica of particular CDMA code, or the entire plurality of replicas of CDMA codes. Other signal generating techniques, including switching and logic circuitry, as is well-known in the art, may be used for generating one or all of the CDMA codes.

In FIG. 7, the received-code means is embodied as a matched filter 71. The matched filter has an impulse response, matched to the particular CDMA code of the spread-spectrum signal being received by the spread-spectrum receiver 70. Preferably, the matched filter 71 is a programmable matched filter, which, by control of processor 72, can change the impulse function of the matched filter 71. The matched filter 71 may be a two-stage, or multi-stage matched filter, depending on systems requirements and design criteria. The matched filter 71 may be a surface-acoustic-wave (SAW) device. In response to detecting the particular CDMA code embedded in the received spread-spectrum signal, the matched filter 71 outputs the particular symbol of the plurality of symbols. The particular symbol typically might be the 1-bit and the 0-bit.

It will be apparent to those skilled in the art that various modifications can be made to the CDMA method and apparatus of the instant invention without departing from the scope or spirit of the invention, and it is intended that the present invention cover modifications and variations of the CDMA method and apparatus provided they come within the scope of the appended claims and their equivalents.

I claim:

1. An improvement to a spread-spectrum receiver, comprising:
a spread-spectrum source having a spread-spectrum signal; and
receiver-code means, coupled to said spread-spectrum source, for spread-spectrum processing the spread-spectrum signal with a particular code-division-multiple-access (CDMA) code from a plurality of CDMA code, having a zero correlation window, with an auto-correlation function, within the zero correlation window, having a value of zero except at an origin, and with a cross-correlation function of the particular CDMA code with other CDMA codes in the plurality of CDMA codes, within the zero correlation window, having a value of zero everywhere inside the zero correlation window.

2. The improvement to the spread-spectrum receiver, as set forth in claim 1, wherein said receiver-code means includes:
a receiver-code generator for generating the particular CDMA code from the plurality of CDMA code; and
a mixer, coupled to said spread-spectrum source, for spread-spectrum processing the spread-spectrum signal with the particular CDMA code.

3. The improvement to the spread-spectrum receiver, as set forth in claim 1, wherein said receiver-code means includes receiver-memory means, coupled to said spread-spectrum source, responsive to the particular CDMA code embedded in the spread-spectrum signal, for storing a plurality of symbols, and for outputting a particular symbol of a plurality of symbols from said receiver-memory means.

4. The improvement to the spread-spectrum receiver, as set forth in claim 1, wherein said receiver-code means includes a matched filter having an impulse function matched to the particular CDMA code, responsive to detecting the particular CDMA code, for outputting a particular symbol of a plurality of symbols.

5. The improvement to the spread-spectrum receiver, as set forth in claim 1, 2, 3, or 4, wherein the plurality of CDMA codes are generated by:
selecting a pair of basically orthogonal complementary code group (C1, S1), (C2, S2) with each code length having N chips, in which an auto-correlation function and cross-correlation functions of code (C1, C2) and code (S1, S2) oppose each other but also complement each other except at the origin, the value of auto-correlation function and cross-correlation functions after summarization are zero except at the origin; and
based on the actually required maximum number of subscriber accesses, spreading, based on the actually required maximum number of subscriber accesses, the code length and code number of the basically orthogonal complementary code group in a tree structure, the values of auto-correlation functions of the spreaded code group are zero except at the origin, while the cross-correlation functions form a zero correlation window about the origin, with the window size at least 2N−1.

6. The improvement to the spread-spectrum receiver, as set forth in claim 5, wherein a size of the zero correlation window is at least a maximum relative time delay inside each CDMA code of the system or between them, the maximum relative time delay is dependent on the summation of the maximum time dispersion of the channel and the timing error of the system.

7. The improvement to the spread-spectrum receiver, as set forth in claim 5, wherein code C and code S are transmitted respectively by using two orthogonal and fading synchronously transmission channels, and carrying the same spread-spectrum signal bits when modulated, while the outputs are added together after de-spreading and demodulation.

8. The improvement to the spread-spectrum receiver, as set forth in claim 5, wherein the spreading the code length and code number of the basically orthogonal complementary code group in a tree structure refers to:
if (C1, S1), (C2, S2) is a pair of basically orthogonal complementary code group with code length N, then the two pairs of orthogonal complementary code group with each code length 2N can be generated according to: 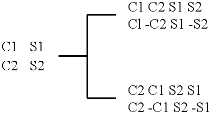
Wherein the values of auto-correlation functions of the orthogonal complementary code group formed on upper and lower trees after spread are zero everywhere except at the origin, while the cross-correlation functions will form a zero correlation window around the origin with the size of the window at least 2N−1.

9. The improvement to the spread-spectrum receiver, as set forth in claim 8, wherein the above spread can be kept going on in accordance with the tree structure so as to generate 2ⁿ⁺¹ orthogonal complementary code groups with the code length N2ⁿ and the width of the zero correlation window at least 2N−1, in which n=0, 1, 2, . . . is the number of spread times.

10. The improvement to the spread-spectrum receiver, as set forth in claim 8, wherein equivalent transformation can be applied to the resultant orthogonal complementary code group.

11. The improvement to the spread-spectrum receiver, as set forth in claim 9, wherein equivalent transformation can be applied to the resultant orthogonal complementary code group.

12. The improvement to the spread-spectrum receiver, as set forth in claim 5, wherein the equivalent transformation can be swap of the forward and backward position of the resultant code group.

13. The improvement to the spread-spectrum receiver, as set forth in claim 11, wherein the equivalent transformation can be swap of the up and down position of the resultant code group.

14. The improvement to the spread-spectrum receiver, as set forth in claim 11, wherein the equivalent transformation can be swap of the up and down position of the resultant code group.

15. The improvement to the spread-spectrum receiver, as set forth in claim 10, wherein the said equivalent transformation can be negation of code order of each code.

16. The improvement to the spread-spectrum receiver, as set forth in claim 11, wherein the said equivalent transformation can be negation of code order of each code.

17. The improvement to the spread-spectrum receiver, as set forth in claim 10, wherein the equivalent transformation can be interlacement of polarity of each code bit.

18. The improvement to the spread-spectrum receiver, as set forth in claim 11, wherein the equivalent transformation can be interlacement of polarity of each code bit.

19. The improvement to the spread-spectrum receiver, as set forth in claim 10, wherein the equivalent transformation can be rotation of each code bit in complex plane in a sequence or without sequence.

20. The improvement to the spread-spectrum receiver, as set forth in claim 11, wherein the equivalent transformation can be rotation of each code bit in complex plane in a sequence or without sequence.

21. The improvement to the spread-spectrum receiver, as set forth in claim 10, wherein the said transformation can be any equivalent transformation that is proven in Mathematics.

22. The improvement to the spread-spectrum receiver, as set forth in claim 11, wherein the said transformation can be any equivalent transformation that is proven in Mathematics.

23. The improvement to the spread-spectrum receiver, as set forth in claim 5, wherein the pair of orthogonal complementary code group (C1, S1), (C2, S2) refers to that the auto-correlation function and cross-correlation function is respectively the summation of acylic auto-correlation function with cross-correlation functions between codes C, and the summation of acylic auto-correlation function with cross-correlation functions between codes S.

24. The improvement to the spread-spectrum receiver, as set forth in claim 23, wherein the code length and the width of the zero correlation window of the pair of basically orthogonal complementary code group can be spread in the following way: 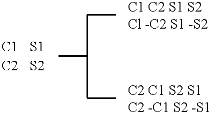
wherein if each code length of the pair of orthogonal complementary code group (C1, S1), (C2, S2) were N, and the width of the zero correlation window were L, then each code length of the spread pair of the orthogonal complementary code group is 2N, while the width of the zero correlation window is 2L+1.

25. The improvement to the spread-spectrum receiver, as set forth in claim 24, wherein when N=2, the pair of orthogonal complementary code group includes:
(++ ′ +−)
(−+ ′ −−)
wherein “+” means +1 and “−” −1, while the width of the zero correlation window is 3.

26. The improvement to the spread-spectrum receiver, as set forth in claim 24, wherein the above spread can be kept going on in accordance with the tree structure so as to generate 2ⁿ pairs of orthogonal complementary code groups with the code length N2ⁿ and the width of the zero correlation window as 2ⁿL+2ⁿ⁻¹+2ⁿ⁻²+2ⁿ⁻³+ . . . +2¹+1, in which n=0, 1, 2, . . . is the number of spread times.

27. The improvement to the spread-spectrum receiver, as set forth in claim 26, wherein an equivalent transformation includes applying to the resultant orthogonal complementary code group.

28. The improvement to the spread-spectrum receiver, as set forth in claim 25, wherein the above spread continues in accordance with the tree structure so as to generate 2ⁿ pairs of orthogonal complementary code groups with the code length N2ⁿ and the width of the zero correlation window as 2ⁿL+2ⁿ⁻¹+2ⁿ⁻²+2ⁿ⁻³+ . . . +2¹+1, in which n=0, 1, 2, . . . is the number of spread times.

29. The improvement to the spread-spectrum receiver, as set forth in claim 28, wherein an equivalent transformation includes applying to the resultant orthogonal complementary code group.

30. The improvement to the spread-spectrum receiver, as set forth in claim 27, wherein the equivalent transformation includes swapping the forward and backward position of the resultant code group.

31. The improvement to the spread-spectrum receiver, as set forth in claim 29, wherein the equivalent transformation includes swapping the forward and backward position of the resultant code group.

32. The improvement to the spread-spectrum receiver, as set forth in claim 27, wherein the equivalent transformation includes swapping an up and down position of the resultant code group.

33. The improvement to the spread-spectrum receiver, as set forth in claim 29, wherein the equivalent transformation includes swapping an up and down position of the resultant code group.

34. The improvement to the spread-spectrum receiver, as set forth in claim 27, wherein the equivalent transformation includes negating code order of each code.

35. The improvement to the spread-spectrum receiver, as set forth in claim 29, wherein the equivalent transformation includes negating code order of each code.

36. The improvement to the spread-spectrum receiver, as set forth in claim 27, wherein the equivalent transformation includes interlacing polarity of each code bit.

37. The improvement to the spread-spectrum receiver, as set forth in claim 29, wherein the equivalent transformation includes interlacing polarity of each code bit.

38. The improvement to the spread-spectrum receiver, as set forth in claim 27, wherein the equivalent transformation includes rotating each code bit in complex plane in a sequence or without sequence.

39. The improvement to the spread-spectrum receiver, as set forth in claim 29, wherein the equivalent transformation includes rotating each code bit in complex plane in a sequence or without sequence.

40. The improvement to the spread-spectrum receiver, as set forth in claim 27, wherein the transformation includes any equivalent transformation that is proven in mathematics.

41. The improvement to the spread-spectrum receiver, as set forth in claim 29, wherein the transformation includes any equivalent transformation that is proven in mathematics.

42. The improvement to the spread-spectrum receiver, as set forth in claim 8, wherein the orthogonal and fading synchronously transmission channel refers to the orthogonal polarized wave.

43. The improvement to the spread-spectrum receiver, as set forth in claim 8, wherein the orthogonal and fading synchronously transmission channel is the time slots without overlap to each other.

44. The improvement to the spread-spectrum receiver, as set forth in claim 5, wherein one code or multiple access codes can be allocated based on the needs of the different spread-spectrum signal rate and services of each subscriber to actualize the different quality of priority level services.

45. The improvement to the spread-spectrum receiver, as set forth in claim 5, wherein the required spreading spectrum access codes can be adaptively generated based on the zero correlation window required by the different propagation modes, different number of subscribers, and the needs of different spread-spectrum signal rate as well as services, so that there are no inter-signal interference (ISI) and multi access interference (MAI) in the corresponding spreading spectrum CDMA system.

46. The improvement to the spread-spectrum receiver, as set forth in claim 5, wherein the resultant multiple access codes by the equivalent transformation including meeting needs of network configuration, handoff and enhancement of system capacity, in cellular mobile or fixed point to multi points wireless telecommunications system.

47. The improvement to the spread-spectrum receiver, as set forth in claim 5, wherein coding includes, as one of the complex codes, using complex codes.

48. The improvement to the spread-spectrum receiver, as set forth in claim 5, wherein with the improvement to the spread-spectrum receiver includes additional circuitry for any of TD/CDMA, FD/CDMA, WD/CDMA, SD/CDMA or CDMA communications system.
